(19) United States
(12) Patent Application Publication
(10) Pub. No.: US 2005/0190073 A1
(43) Pub. Date: Sep. 1, 2005

(54) Noise resistant remote control system

(76) Inventors: Jon Berges, San Clemente, CA (US); Jerry Curtis, Buena Park, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/059,574

(22) Filed: Feb. 16, 2005

Related U.S. Application Data
(60) Provisional application No. 60/546,500, filed on Feb. 20, 2004.

(51) Int. Cl. H04Q 1/00

(52) U.S. Cl. 340/825.72; 340/825.25; 398/112

(57) ABSTRACT

A method for providing control commands to electronic equipment from a remote location comprises receiving a control command signal transmitted from a remote location The control command signal has a first carrier wave that includes a noise component. The method further comprises removing the first carrier wave from the control command signal, such that the noise component is also removed, thereby producing a TTL signal. The method further comprises generating a second carrier wave having a frequency substantially equal to the first carrier wave. The method further comprises applying the second carrier wave to the TTL signal to produce an output command signal.

### PRIORITY APPLICATION

This application claims the benefit of U.S. Provisional Patent Application 60/546,500, filed on 20 Feb. 2004, the entire disclosure of which is hereby incorporated by reference herein.

### FIELD OF THE INVENTION

The present invention relates generally to a remote control systems for home electronics equipment, and more specifically to infrared remote control systems.

### BACKGROUND OF THE INVENTION

Equipment can be controlled from a remote location using a wide variety of applicable remote control systems. For example, in the field of home electronics, remote control systems are often used to control equipment such as stereo systems, television sets, computers and video equipment. In one class of remote controls commonly used in the home electronics field, an infrared signal, including embedded command codes, is generated at a location remote from the equipment to be controlled. The infrared signal propagates to the equipment to be controlled, where it is detected and decoded using an infrared detector and signal processing circuitry. These systems provide the convenience of remote operation without the nuisance of running wires or other cables from the equipment to the remote operation location.

### SUMMARY OF THE INVENTION

While conventional infrared remote control systems are convenient in many respects, the use of infrared signals to transmit control commands does suffer certain limitations. For example, other sources of infrared energy can interfere with the infrared signal, thereby causing the detector or decoder to misread the infrared signal or to detect false signals. In the field of home electronics, plasma televisions and fluorescent lighting are common sources of infrared noise that can deleteriously interfere with the operation of a conventional infrared remote control system. For example, a typical plasma television generates infrared radiation in the non-visible light spectrum at approximately 1000 μm, while a typical infrared remote control broadcasts command signals at approximately 940 μm. In view of this, a noise-tolerant infrared remote control system has been developed that is capable of reliable operation near sources of infrared noise.

In accordance with the foregoing, in one embodiment of the present invention, a method for providing control commands to electronic equipment from a remote location comprises receiving a control command signal transmitted from a remote control. The control command signal has a first carrier wave that includes a noise component. The method further comprises removing the first carrier wave from the control command signal, such that the noise component is also removed, thereby producing a TTL signal. The method further comprises generating a second carrier wave having a frequency substantially equal to the first carrier wave. The method further comprises applying the second carrier wave to the TTL signal to produce an output command signal that is provided to the electronic equipment to be controlled remotely.

In another embodiment of the present invention, a method comprises receiving, at a detector, a command signal from a remote control. The command signal includes a spectrum of frequencies. The method further comprises determining a range of noise frequencies based on a noise source to which the detector is exposed. The method further comprises passing selected frequencies of the command signal to an output port. The range of noise frequencies is removed from the command signal.

In another embodiment of the present invention, a remote control apparatus comprises a photodetector configured to receive an infrared signal generated by a remote control. The photodetector is exposed to a source of electromagnetic noise. The apparatus further comprises an input circuit for generating a command signal from the infrared signal detected by the photodetector. The command signal includes a logic portion, a carrier portion and a noise portion. The apparatus further comprises a filter circuit for removing the carrier portion and noise portions of the command signal, thereby providing a TTL logic signal that is substantially free from effects of electromagnetic noise. The apparatus further comprises a circuit for generating a replacement carrier signal at a selected frequency, such as a clock circuit or a microcontroller. The replacement carrier signal is then added to the command signal logic portion. The apparatus further comprises an output terminal configured to output the command signal logic portion and the replacement carrier signal.

In another embodiment of the present invention, a system comprises a remote control for generating a command signal. The system further comprises a receiver box that is exposed to a source of electromagnetic noise. The receiver box is configured to receive the command signal form the remote control, remove a noise component of the command signal, and output a filtered command signal. The receiver box is positioned remotely from the remote control. The system further comprises an electronic component configured to receive the filtered command signal from the receiver box.

### BRIEF DESCRIPTION OF THE DRAWINGS

Exemplary embodiments of the remote control system described herein are illustrated in the accompanying drawings, which are for illustrative purposes only. The drawings comprise the following figures, in which like numerals indicate like parts.

FIG. 1 is a schematic diagram illustrating certain components of an exemplary embodiment of an improved infrared remote control system.

FIGS. 2A and 2B are circuit diagrams of an exemplary microcontroller circuit capable of removing noise from an infrared signal.

FIG. 3A is a circuit diagram of a first exemplary clock circuit capable of removing noise from an infrared signal.

FIG. 3B is a circuit diagram of a second exemplary clock circuit capable of removing noise from an infrared signal. FIG. 3B includes two parts, FIGS. 3B-1 and 3B-2.

FIG. 4 is a schematic illustration of an exemplary technique for removing noise using the circuit of FIG. 2.

### DETAILED DESCRIPTION OF PREFERRED EMBODIMENTS

As described above, sources of background infrared radiation, such as plasma televisions and fluorescent lighting, can interfere with the operation of conventional infrared remote control systems, such as those often associated with home electronics systems. Specifically, conventional infrared detectors often cannot distinguish between the infrared signals generated by the remote control and background infrared noise. This can result in the detector misreading the infrared signal or detecting a false signal.

System Overview.

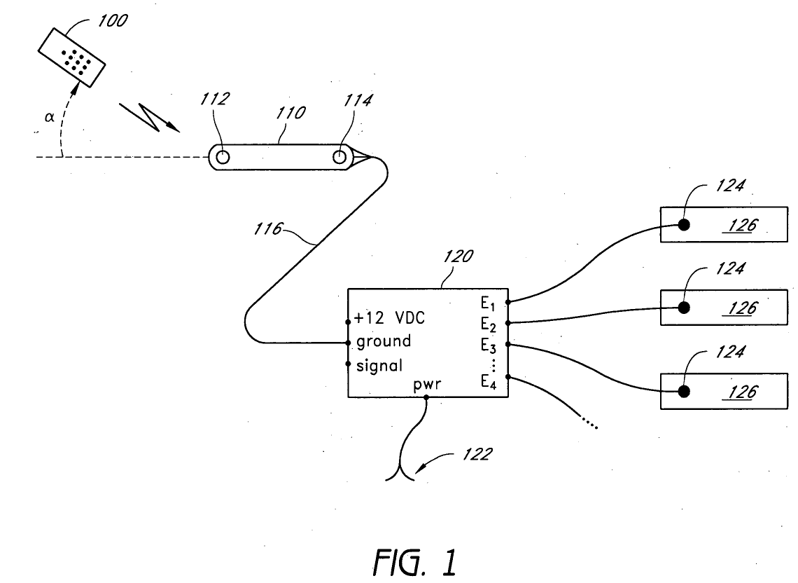

FIG. 1 illustrates certain components of an exemplary embodiment of a noise-tolerant infrared remote control system. The illustrated system can be used in the form of a remote control relay system, wherein the relay system receives remote control signals from a remote control transmitter, processes those signals, and then transmits the processed signals to a target device, such as a multimedia system device.

As illustrated, the system includes a handheld infrared remote control 100 capable of generating infrared signals, such as with an infrared light emitting diode (“LED”). For example, the remote control can generate a square wave plus carrier signal that is gated by a logic signal to thereby embed control data or codes. This signal is then used to drive or pulse one or more infrared LED emitters, wherein the logic signal modulates the square wave signal, which acts as a carrier.

In one example embodiment, the infrared remote control 100 comprises a user programmable “universal” remote control that is capable of providing control commands to a variety of different home electronics components, such as television sets, including plasma, CRT, and LCD television sets, satellite receivers, video cassette recorders, DVD players, digital video recorders, and stereo receivers. In other embodiments, the infrared remote control 100 is configured for use with a single component.

Still referring to FIG. 1, the system further comprises an infrared receiver 110. The infrared receiver 110 includes a detector 112 capable of detecting infrared signals generated by the infrared remote control 100. For example, in one embodiment the detector 112 comprises a photodiode capable of converting the detected infrared signals into electronic signals. By way of example, the detector 112 is configured to detect infrared signals generated up to a selected distance, such as approximately 25 feet away from the infrared receiver 110, and at a selected angle, such as an angle α of approximately ±55°, off axis from the detector 112. The selected distance depends on a variety of characteristics, such as the power of the transmitter in the remote control 100 and the sensitivity of the infrared receiver 110. For example, the remote control battery strength affects the transmitter power; the quality of the receiver and the filter lens type affects the sensitivity of the infrared receiver 110.

The infrared receiver 110 further includes electronic circuitry, described in greater detail below, configured to selectively remove or filter infrared noise detected by the detector 112, such as might be generated by plasma television sets, fluorescent lighting, or other sources of infrared radiation. The circuitry is optionally housed within a shielded chassis. Additionally, the infrared receiver 110 optionally includes a talkback LED 114 configured to emit visible light when the detector 112 detects an infrared signal. In such embodiments, the talkback LED 114 provides the user with an indication that the detector 112 has detected an infrared signal.

In one embodiment, the infrared receiver 110 has a compact design, thus facilitating its placement in small or inconspicuous locations, such as under shelf edges or cabinet ledges. For example, in one embodiment the infrared receiver 110 measures approximately 11 mm wide, approximately 8.5 mm deep, and approximately 55 mm long. Other dimensions can be used in other embodiments. The receiver optionally includes screw holes used to affix the receiver to a surface, such as a shelf, using screws or nails, though two-sided tape or other affixing mechanisms can be used as well.

Still referring to the exemplary embodiment illustrated in FIG. 1, the infrared receiver 110 is configured to provide the filtered and detected signal to a connecting block 120 via cable 116. In addition, the connecting block 120 is configured to provide power to the infrared receiver 110 via the same cable 116. In such embodiments, the cable 116 comprises a three-conductor ribbon cable, with separate conductors for power, ground, and signal. In one embodiment, the power signal is +12 V direct current (“DC”). The connecting block 120 is connected to a power source 122. In one embodiment, the connecting block 120 is the CB1 Connecting Block, available from Sonance (San Clemente, Calif.). In other embodiments, the receiver 110 can be battery powered, or otherwise powered.

The connecting block 120 is configured to provide the signal received from the infrared receiver 110 to one or more emitter ports E₁, E₂, E₃, . . . En. An infrared emitter 124 is connected to an emitter port En, with the emitter mounted over, or in view of, the infrared detector on a home electronics component 126. The electronic component can include one or more television sets, satellite receivers, video cassette recorders, DVD players, digital video recorders, cable boxes, tuners, computers, and multichannel audio components. For example, in one embodiment, the infrared emitters 124 comprise E1 IR Emitters, available from Sonance (San Clemente, Calif.), though other infrared emitters can be used. In a modified embodiment, the connecting block 120 is eliminated, and the infrared receiver 110 is connected directly to a power supply and the infrared emitter 124, thereby directly providing the home electronics component 126 with the filtered signal produced by the infrared receiver 110.

Using the configuration described above, and illustrated in FIG. 1, infrared signals generated by the infrared remote control 100 can be transmitted to a plurality of home electronics components 126. The signal is passed through the infrared receiver 110, which contains circuitry configured to reduce or eliminate background infrared noise, such as that generated by plasma televisions, fluorescent lighting, or sunlight, at selected frequencies. Thus, the system described herein is capable of reliable operation near such sources of infrared noise.

Infrared Filter Circuit.

As described above, the infrared receiver 110 contains electronic circuitry configured to selectively remove noise detected by the detector 112, such as might be generated by plasma television sets or fluorescent lighting.

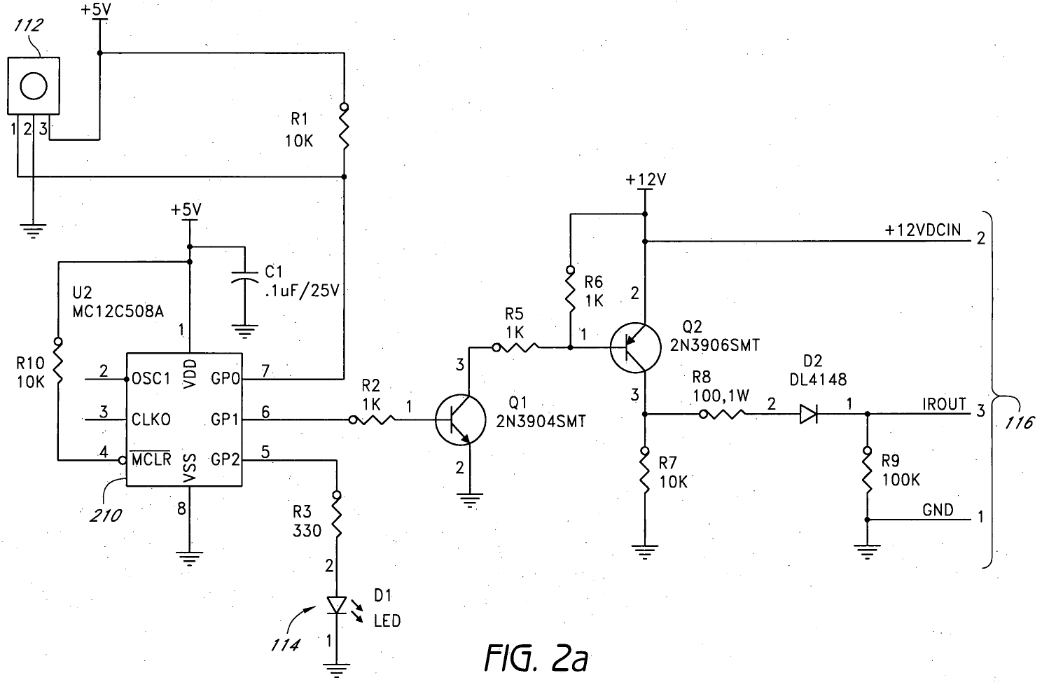

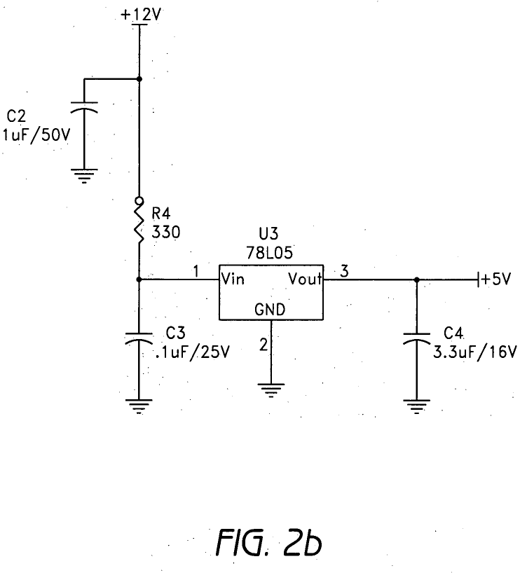

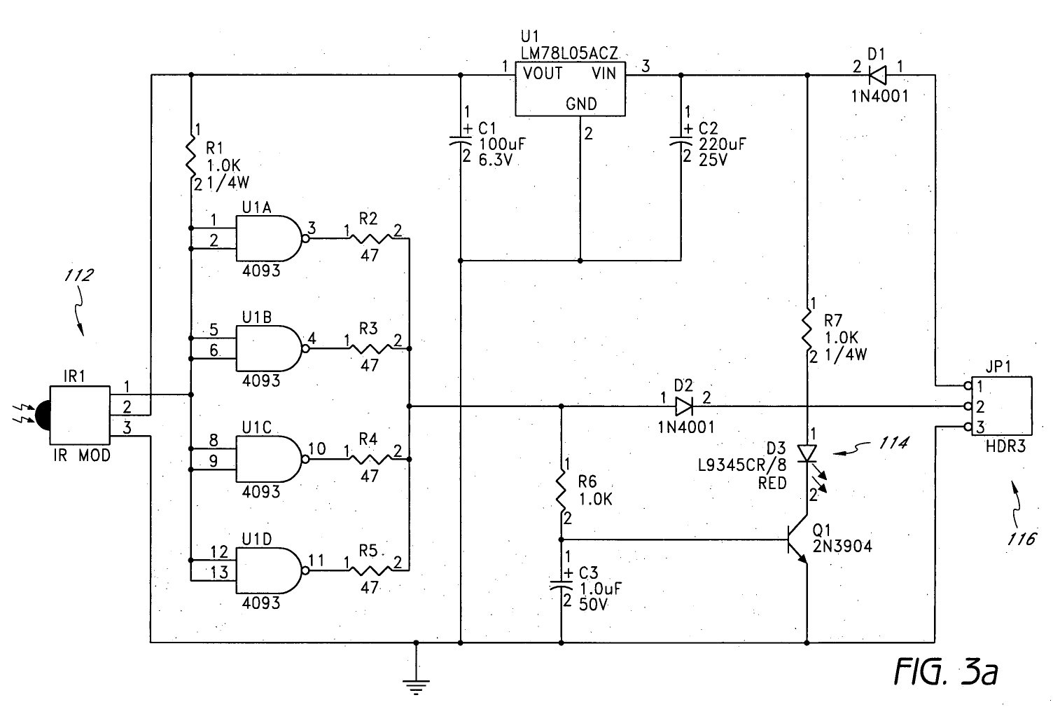

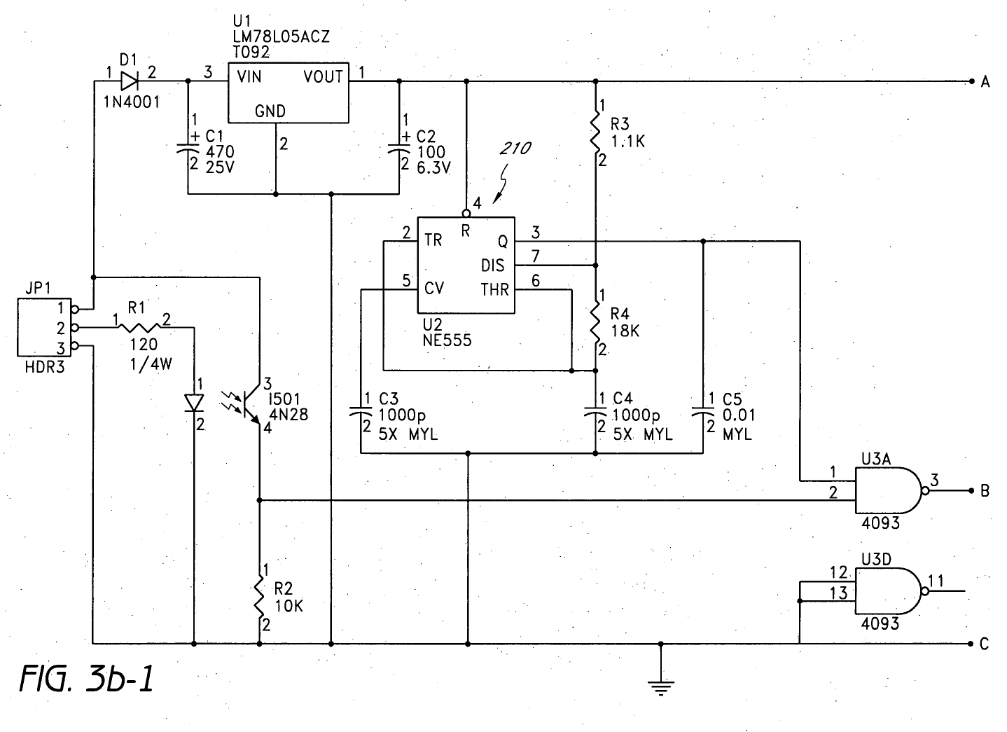

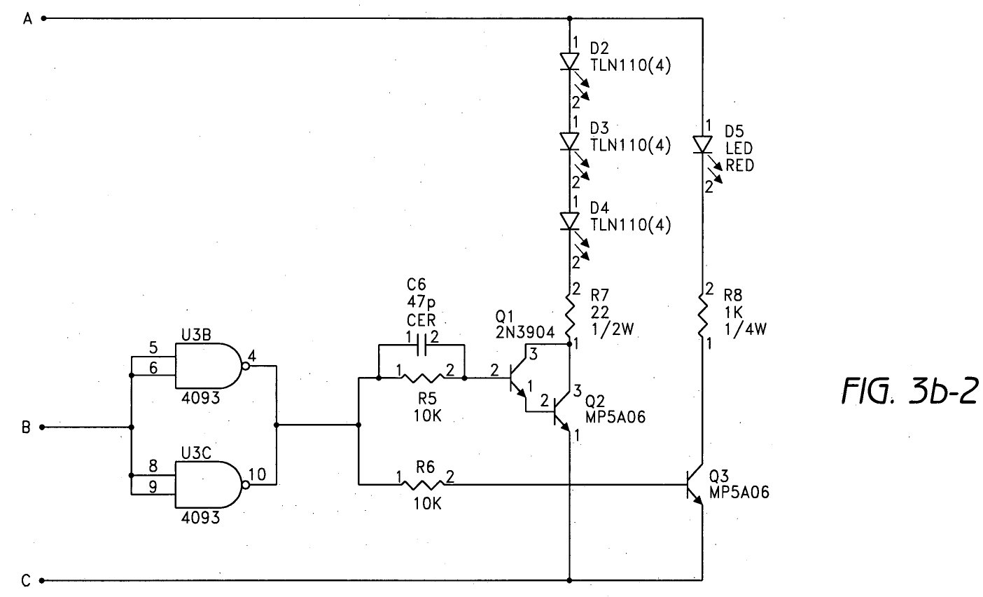

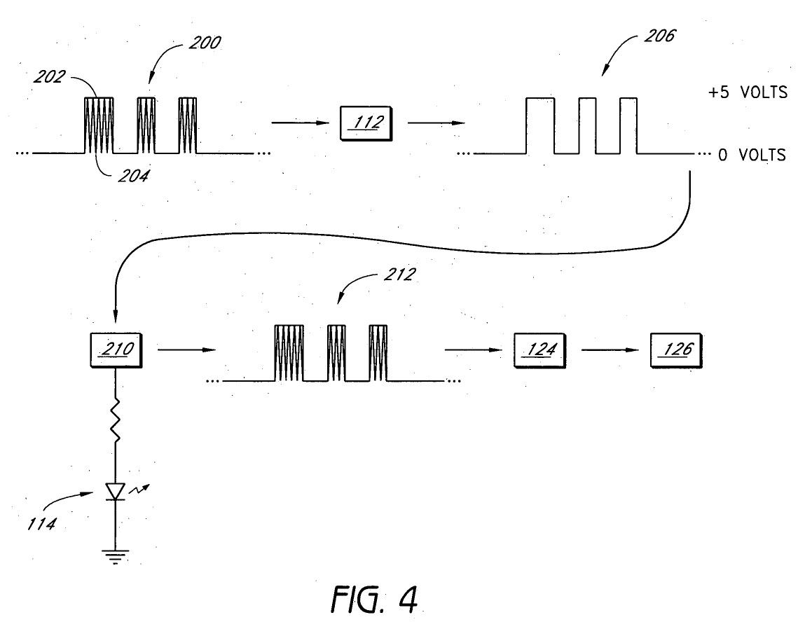

In the illustrated embodiment, the detector 112 is a photodiode. An exemplary embodiment of such circuitry is provided in FIGS. 2A, 2B, 3A and 3B. In other embodiments, similar circuits can also be used to remove infrared noise detected by the detector 112. Therefore, it should be recognized that the parameters provided in FIGS. 2A, 2B, 3A and 3B are exemplary, and are not intended to limit the present invention. FIG. 4 is an illustration of an exemplary technique for removing noise using the circuit illustrated in FIGS. 2A, 2B, 3A and 3B.

Referring now to FIG. 4, an infrared signal 200 impinging on the infrared detector 112 includes a binary or digital command signal 202 (for example, generated by the infrared remote control 100) and a carrier wave 204. The binary command signal 202 typically comprises a plurality of pulses ranging in duration from approximately 20 ms to approximately 100 ms, though other pulse durations can be used as well. The carrier wave 204 usually has a frequency between about 36 kHz and 44 kHz, although the particular frequency used can depend on the configuration of the equipment to be controlled. For example, other commonly used carrier frequencies are in the range of between about 35 kHz and about 56 kHz, between about 38 kHz and about 40 kHz, or between about 36 kHz and about 100 kHz. The carrier wave 204 may include infrared noise from external sources, such as plasma televisions and fluorescent lighting, as described above.

The infrared signal is detected by the infrared detector 112, which removes the carrier wave 204 to produce a transistor-transistor logic (“TTL”) signal 206, for example ranging between 0 volts and +5 volts. Exemplary infrared detectors 112 that can be used to remove the carrier wave 204 are manufactured by Panasonic (Osaka, Japan) under part numbers PNA 4602M/4612M (for removing a 38 kHz carrier wave) and PNA 4608M/4614M (for removing a 56.9 kHz carrier wave). Of course other voltage ranges can be used, including those that are compatible with CMOS circuitry, ECL circuitry, GaAs circuitry, and the like. In a modified embodiment, wherein infrared signals having different carrier frequencies are to be detected, the infrared receiver 110 includes a plurality of detectors 112, each tuned to detect an infrared signal 200 having a different carrier frequency.

Still referring to the exemplary technique illustrated in FIG. 4, the TTL signal 206 is provided to microcontroller 210. In one embodiment, microcontroller 210 comprises a PIC 12C 508A, available from Microchip Technology, Inc. (Chandler, Ariz.). Other processor, microcontroller, and/or state machine devices can be used in other embodiments. The microcontroller 210 includes a 4 MHz internal oscillator that, when used in conjunction with a frequency divider, can be used to generate a “clean” carrier wave that does not contain infrared noise from external sources such as described above. The “clean” carrier wave, which has a frequency selected to be between about 36 kHz and about 44 kHz in an exemplary embodiment, is applied to the TTL signal 206, thereby producing a filtered signal 212 that corresponds to the incoming infrared signal 200. In an exemplary embodiment, the frequency of the carrier wave is selected to correspond to the frequency that the infrared receiver is tuned to. In circuits including a microcontroller 210, such as illustrated in FIGS. 2A and 2B, this frequency can be controlled by firmware (by the manufacturer), or by software (by the user). In circuits using a clock design, such as illustrated in FIGS. 3A and 3B, a potentiometer can be used to adjust the carrier frequency. The microcontroller 210 optionally provides to talkback LED 114 a signal that corresponds to the filtered signal 212, thereby providing the user with a visual indication that the detector 112 has detected the infrared signal 200.

In the exemplary technique illustrated in FIG. 4, the filtered signal 212 is amplified by amplifier 212, and the amplified signal is then passed to an infrared emitter 124 which can be used to provide a control signal to, for example, a home electronics component 126. As described above, the infrared emitter 124 can be co-located with the control circuitry described herein, or can be disposed remotely, with the control signal distributed to a connecting block 120, as illustrated in FIG. 1.

### SCOPE OF THE INVENTION

While the foregoing detailed description discloses several embodiments of the present invention, it should be understood that this disclosure is illustrative only and is not limiting of the present invention. It should be appreciated that the specific configurations and operations disclosed can differ from those described above, and that the methods described herein can be used in contexts other than home electronics.

1. A method for providing control commands to electronic equipment from a remote control device, the method comprising:
receiving a control command signal transmitted from a remote control transmitter at a remote location, the control command signal has a first carrier wave, wherein the first carrier wave includes a noise component from a first source;
removing the first carrier wave from the control command signal so as to also remove the noise component;
generating a second carrier wave having a frequency substantially equal to the first carrier wave; and
modulating the second carrier wave with the control command signal after the first carrier wave has been removed to produce an output command signal.

2. The method of claim 1, wherein the control command signal is an infrared signal, and wherein the control command signal is received using a photodetector.

3. The method of claim 1, wherein the first carrier wave has a frequency between about 36 kHz and about 44 kHz.

4. The method of claim 1, wherein the first carrier wave has a frequency between about 36 kHz and about 56 kHz.

5. The method of claim 1, wherein the first carrier wave has a frequency between about 36 kHz and about 100 kHz.

6. The method of claim 1, wherein the noise component of the first carrier wave is produced by electromagnetic radiation generated by a plasma television set.

7. The method of claim 1, wherein the noise component of the first carrier wave is produced by electromagnetic radiation generated by a fluorescent lighting.

8. The method of claim 1, wherein the second carrier wave is generated by a processor circuit.

9. The method of claim 1, wherein the second carrier wave is generated by a clock circuit.

10. The method of claim 1, wherein the second carrier wave is generated by a circuit comprising a processor, an oscillator and a frequency divider.

11. The method of claim 1, further comprising generating a visible talkback signal corresponding to the output command signal.

12. A method of filtering a remote control device signal, comprising:
receiving at a detector an infrared command signal from a remote control transmitter, the command signal including a noisy carrier at a first frequency and remote control command data that modulates the carrier;
selectively filtering out the carrier at the first frequency;
using a second carrier to carry the remote control command data to a receiving device.

13. The method of claim 12, wherein the selective filtering is configured to remove noise generated by a plasma television set.

14. The method of claim 12, wherein the first frequency is between about 36 kHz and about 44 kHz.

15. The method of claim 12, wherein the carrier noise is caused by a plasma television set producing electromagnetic radiation received by the detector.

16. The method of claim 12, further comprising the receiving device, wherein the receiving device includes at least one component selected from the group of a television set, a satellite receiver, a video cassette recorder, a DVD player, a digital video recorder, a cable box, a radio, a computer, and a multichannel audio components.

17. The method of claim 12, wherein the carrier noise is caused by fluorescent lighting producing electromagnetic radiation received by the detector.

18. The method of claim 12, wherein the detector is a photodetector.

19. A remote control apparatus comprising:
a photodetector configured to receive an infrared signal generated by a remote control, wherein the photodetector is exposed to a source of electromagnetic noise in the non-visible light spectrum;
an input circuit for generating a command signal from the infrared signal detected by the photodetector, the command signal including a logic portion, a carrier portion and a noise portion;
a filter circuit for removing the carrier portion and the noise portion of the command signal, thereby providing a logic signal corresponding to the command logic portion that is substantially free from effects of the electromagnetic noise;
a circuit that generates a replacement carrier signal and that modulates the replacement carrier signal with the logic signal; and
an output terminal configured to output the modulated replacement carrier signal.

20. The remote control apparatus of claim 19, wherein the command signal carrier portion has a frequency between about 36 kHz and about 44 kHz.

21. The remote control apparatus of claim 19, wherein the command signal carrier portion and the command signal noise portion include substantially similar frequencies.

22. The remote control apparatus of claim 19, wherein the source of electromagnetic noise is a plasma television set.

23. The remote control apparatus of claim 19, wherein the source of electromagnetic noise is fluorescent lighting.

24. The remote control apparatus of claim 19, further comprising a talkback LED configured to visually display the signal provided on the output terminal.

25. A system comprising:
a remote control for generating a command signal; and
a relay system, including a receiver which can be exposed to a source of light noise, the relay system configured to receive the command signal in the form of an infrared signal from the remote control, remove from the command signal a noise component caused by the light noise, and output a filtered infrared command signal, wherein the relay system is positioned remotely from the remote control.

26. The system of claim 25, further comprising an electronic component configured to receive the infrared filtered command signal from the relay system.

27. The system of claim 25, wherein the command signal includes a carrier signal having a frequency between about 36 kHz and about 44 kHz.

28. The system of claim 25, wherein the command signal is an infrared signal having a frequency component that overlaps a frequency component of the light noise.

29. The system of claim 25, wherein the source of light noise is a plasma television set.

30. The system of claim 25, wherein the source of light noise is fluorescent lighting.

31. The system of claim 25, wherein the relay system further includes a talkback LED configured to visually display the filtered signal.
